(19) United States
(12) Patent Application Publication
(10) Pub. No.: US 2022/0039923 A1
(43) Pub. Date: Feb. 10, 2022

(54) DENTAL IMPLANT

(71) Applicant: Georgia TRIMPOU, Frankfurt am Main (DE)

(72) Inventor: Georgia TRIMPOU, Frankfurt am Main (DE)

(21) Appl. No.: 17/418,712

(22) PCT Filed: Dec. 16, 2019
(86) PCT No.: PCT/EP2019/085432

§ 371 Date: Jun. 25, 2021

(30) Foreign Application Priority Data
Dec. 22, 2018 (DE) 10 2018 222 901.5

(51) Int. Cl. A61C 8/00

(52) U.S. Cl. CPC A61C 8/0025; A61C 8/0013

(57) ABSTRACT

A dental implant intended for insertion into the jawbone of a patient and having a basic body which is provided with a circumferential external thread in an apically arranged screw region on its outer side is intended, on the one hand, to permit a particularly high primary and secondary stability and thus to particularly favor the healing process and, on the other hand, to facilitate in a particularly favorable manner the containment or treatment of an inflammation which may occur in the surrounding bone tissue. For this purpose, according to the invention, the base both is designed to be thread-free in a proximal shaft region provided in addition to the screw region.

### CROSS-REFERENCE TO RELATED APPLICATIONS

This application is the United States national. phase of international application PCT/EP2019/085432, filed Dec. 16, 2019, which claims priority to German application DE 102018222901.5, tiled Dec. 22, 2018. Both applications are hereby incorporated by reference in their entirety.

### FIELD OF INVENTION

The invention relates to a dental implant intended for insertion into the jawbone of a patient, with a base body which on its outer side in an apically arranged screw region is provided with a circumferential external thread.

### BACKGROUND OF INVENTION

Over the last four decades, oral implantology has increasingly developed from a special to a routine therapy after tooth loss. The dental implants used for this are known in many different forms. They are usually inserted by screwing them into the patient's jawbone in place of an extracted or lost tooth in order to hold a prosthetic abutment or crown there after a healing phase of three to four months. For this purpose, such a dental implant is usually designed as a suitably shaped metal body and shaped in the manner of a pin and has a mostly self-tapping screw thread at the apical end, with which the pin is inserted into the correspondingly prepared implant bed in the jawbone. If there is sufficient bone available, there is then a high probability for the so-called osseointegration of the implants, which can sustainably anchor a dental prosthesis that is functionally loaded by masticatory forces. Currently, the most frequent indication and thus application (60-80%) of oral implants is the restoration of single-tooth loss with an implant to which a single-tooth crown is attached.

The so-called primary stability on the one hand and the secondary stability on the other hand are essential for the healing of the implant in the jaw bone and thus for the overall success of the treatment. When the implant is inserted, a round bone cavity or hollow is usually created in the jawbone at the intended site, preferably by drilling (osteotomy). The implant screw is then screwed into this cavity. The thread .flanks anchor themselves in the peri-implant bone purely mechanically, whereas a firm, rigid connection (also called osseointegration) between the bone and the implant surface is still missing directly alter implant phicement. The initial. mechanical anchorage, also referred to as primary stability, thus depends, among other things, on the design of the threads.

After implant placement, remodeling processes of the peri-implant bone begin. Depending on the applied trauma and the insertion process, osteotemia causes the formation of a peri-implant surrounding layer in the bone, which has not survived the trauma (“death zone”). This layer is initially degraded by osteoclasts and, in the case of extensive death zones, leads to a reduction in the mechanical anchorage of the implant (secondary stability) after two to four weeks of healing. The latter endangers the clinical success or osseointegration of immediately loaded or prosthetically restored implants, especially single-tooth implants and implants that are immediately placed in the alveolus and immediately restored with single crowns after tooth. extraction or traumatic tooth loss.

In the course of progressive healing, usually in a time range of about 8 to 12 weeks after insertion, the actual osseointegration then takes place. A strong, rigid bond is formed between the implant surface and the hone tissue. This bond is ultimately essential for the load-bearing capacity of the placed implant, for example, against the applied masticatory forces.

Another significant factor for the long-term success of treatment when placing a dental implant is the possibility of an infection or inflammation of the surrounding bone tissue, also known as peri-implantifis. indeed, the risk of implant loss after successful osscointegration correlates strongly with the condition of the peri-implant soft tissue, which acts as a barrier between the germ-infested oral cavity and the alveolar bone. The adhesion of the oral soft tissue to the implant surface and the resulting sealing function against the oral cavity can be negatively influenced by a number of factors. Clinically, an inflammation of the soft tissue occurs first in the case of infection. This condition, known as mucositis, is similar to gingivitis in that both can heal completely. However, if mucositis persists or spreads, the inflammatory process extends to the peri-implant bone and results in irreversible crestal bone loss. This stage of the disease is referred to as peri-implantitis. Mucositis should therefore be regarded as a preliminary stage to peri-implantitis.

Despite a variety of therapeutic concepts, the progression of peri-implantitis can hardly be prevented because the implant surface, which is usually designed to be rough in order to. promote osseointegration, has the undesirable side effect of promoting the formation and attachment of a biofilm and thus a bacterial colonization.

### BRIEF SUMMARY OF INVENTION

It is now an objective of the present invention to provide a dental implant of the above-mentioned type which, on the one hand, enables a particularly high primary and secondary stability and thus particularly favors the healing process, and, on the other hand, facilitates in a particularly favorable manner the containment or treatment of an inflammation which may occur in the surrounding bone tissue.

According to the invention, this task is solved in that the base body of the dental implant is designed to he thread-free in a proximal shaft region provided in addition to the screw region.

The dental implant screw according to the invention thus essentially comprises two regions, namely, on the one hand, the anchoring region provided at the apical end and provided with an external thread and limited exclusively to a “lower” partial region of the total length of the implant and, on the other hand, the “upper” shaft region Which directly adjoins this anchoring region, as seen in the longitudinal direction, and is thread-free and thus comparatively smooth in terms of the macroscopic structure.

The invention is based on the consideration that, on the one hand, the primary and secondary stability of the inserted dental implant, which is essential for the success of the treatment, is essentially determined by the thread provided in the lower end region of the base body and its anchoring in the hone tissue; in contrast, the contributions to stability made by threads located in the upper shaft region are largely insignificant. On the other hand, however, threads in the upper shaft region tend to be a hindrance, particularly in measures against existing or incipient inflammation, since they promote the adhesion of biofilm and make therapeutic access to the connection area between bone tissue and implant surface more difficult. Therefore, the basic body of the implant should be consistently kept free of threads in its “upper” endosseous shaft area.

In particular, it is advantageously taken into account that comparatively deep thread flanks (i.,e, the formation of the external thread as a comparatively “aggressive”, self-tapping thread) are disadvantageous, especially for insertion in hard bone. These require a corresponding, usually complex osteotomy protocol—in some cases with thread sheaths in the hard bone—to enable the implant screw to be screwed in without excessive insertion torques (<100-150 Ncm). Therefore, implant screws with deep thread flanks are mainly used clinically in soft bone—mainly occurring in the maxilla. Another clinical application is implant placement immediately after tooth loss, .i.e, screwing, the implant into the tooth socket. Due to the incongruence between the conically shaped tooth socket and the round implant screw, usually only the first 4 to 5 mm of the implant screw can be screwed into the bone anyway, with the rest of the screw no longer in contact with the bony aveolar walls. Therefore deep thread flanks are placed especially at the tip of the implant screw in order to be able to achieve a high mechanical primary stability of implants even immediately after tooth. loss. The latter enables immediate and ideal wound closure of the dental socket with a crown anchored to the implant and a functionally and esthetically high-quality prosthetic restoration for the patient immediately after tooth loss.

Furthermore, it is advantageously taken into account that when osseointegration is complete, i.e. after a healing time of usually about 8 to 12 weeks, a firm, rigid bond is created between the bone tissue and the implant surface. This strong bond between peri-implant bone and the implant surface enables a mechanical anchoring quality of the implant that is independent of the thread design, especially in the upper shaft area of the implant base body. In other words, implants with small thread flanks or completely missing threads do not show any indication restrictions regarding their mechanical loading capacity by prosthetic restoration concepts after complete osseointegration. This is also confirmed by the observed tong-term clinical behavior of short implant screws with conventional implant diameters. In spite of a considerably reduced implant surface, the mechanical loading capacity of these implants is identical to that of longer implants after complete osseointegration.

From these findings, it is concluded that the thread area required for stability can be limited to the apical area of the implant base body without having to accept excessive impairment of the load-hearing capacity of the implant. This can be used to consistently design the dental implant in its “upper” shaft area to favor any treatment measures that may be required. if inflammation occurs.

Inflammation of the peri-implant soft tissue (mucositis) can he triggered and/or maintained by various factors. The etiology of mucositis is therefore multifactorial. A single factor can be causative for its pathogenesis. The development and progression of mucositis are also supported by the interaction of a number of factors, not all of which have probably been identified to date. Due to the comparatively high prevalence of mucositis (64.5%) and the resulting peri-implantitis (12.9%), prophylactic therapies or measures are also becoming increasingly important in order to prevent premature implant and/or bone loss.

Such prophylactic approaches aim at avoiding or minimizing irritation or inflammation of the peri-implant soft tissue. Therefore, it is desirable to identify the potential risk factors and indicators for mucositis and peri-implantitis responsible for this. In oral implantology, risks for the development of mucositis include: a material that is not optimally biocompatible, a rough surface, a liquid contaminated with toxins or metal particles, and a biofilm that is difficult to remove. A traumatic or an incorrectly performed therapeutic step during the fabrication of prostheses anchored to the implant also increases the risk of mucositis.

A very frequently used therapeutic approach in case of occurring inflammations is the smoothing of the implant surface in the upper shah area, which includes the removal of existing thread flanks (so-called implantoplasty). The disadvantage of this is the contamination of the peri-implant soft and bone tissue with Ti chips produced during grinding anti the reduction of mechanical strength. In addition, explanation or removal of the implant is often the method of choice to prevent further bone resorption. The latter would also lead to implant loss with a time delay.

The indication for the removal of an implant is either due to its technical and/or biological failure or in the ease of a mostly psycho-somatic implant phobia of the patient. Technical failure often occurs as a late complication as a result of material fatigue. The implants fracture or show cracks at the junction between the implant and the prosthetic abutment. Both no longer allow functional loading of the implant. The biological failure of an implant, on the other hand, is often a consequence of progressive inflammation of the peri-implant soft tissue (mucositis/peri-implantitis), as described above. Moreover, due to the unmasking of the implant surface, sometimes esthetically unacceptable situations arise, which are countered either with surgical interventions for tissue regeneration or with explantation. Furthermore, early explantation prevents progressive and irreversible peri-implant tissue loss. In rare eases, patients develop anxiety and phobias after implant placement. They wish to “metal-free” in their jawbone despite successful osseointegration or attribute the cause of their diseases to these implants. Both lead to the desire for premature removal of the implant despite the fact that the technical and/or biological failure of the implant has not occurred.

If the removal of a fully or a still partially osseointegrated implant is required for one of the above reasons, this can be performed using different techniques. Clinical experience shows that the difficulty and the associated bone loss increase with the osseointegrated implant length and diameter, as well as with the length and for the shape of the thread flanks. All the parameters mentioned increase the contact area with the attached bone tissue and thus the torque to he overcome to unscrew the implant screw. Trephine drills also destroy more peri-implant hone tissue with increasing implant length and diameter. Short and narrow implants as well as implants without threads or very short thread flanks, on the other hand, facilitate the unscrewing of an implant screw to be removed. Minimal peri-implant bone loss can therefore be assumed.

The aforementioned findings are taken into account in the present case by the fact that the implant screw is designed to be thread-free in its “upper” or endosteal shaft. region from the outset. In the event of a therapeutic intervention for one of the reasons mentioned, the removal. of threads is thus not necessary from the outset, and the risk of contamination or stress on the surrounding tissue due to metal chips or the like is avoided.

In other words, the invention takes advantage of the realization that the major contributions to the stability and mechanical load-bearing capacity of the implant are made by the apical end region of the screw thread to ensure that the upper, endosteal shaft region can and should be kept thread-free. This facilitates access to the implant surface when therapeutic measures become necessary, makes it easier to remove the inserted implant if necessary, and reduces the risk of metal chips stressing the surrounding tissue. Accordingly, the end region. carrying the screw thread and thus the thread itself; viewed in the longitudinal direction of the implant, should preferably he limited to a length of at most 4 mm, preferably at most 3 mm.

Advantageous embodiments of the invention are the subject of the dependent claims.

In a very particularly preferred embodiment, the shaft region of the base body is designed with an outer surface suitably selected with respect to the desired properties, preferably with a machined or polished outer surface.

From a macroscopic point of view, the base body is thread-free in the shank region and thus smooth. From a microscopic point of view, however, the surface structure of the basic body in the shaft region is advantageously particularly suitable for the desired osseointegration. For this purpose, the base body in the shaft region very preferably has an outer surface with a roughness having a roughness value Ra of at least 1 μm. Preferably, the roughness Value Ra should not exceed 3.5 μm. Particularly preferably, a roughness value Ra of between 1.5 μm and 3.5 μm is provided for the outer surface. In an alternative or additional advantageous further development, however, the base body also has a surface in its shaft region which is particularly favorable for osseointegration in terms of its structure. For this purpose, the thread-free part of the endosseous implant body preferably has a surface with a stochastic or deterministic pattern.

In an additional or alternative advantageous embodiment, the base body is designed for even further improved osseointegration in that the thread-free part or shaft region of the endosseous implant body has a coated or physically, chemically and/or optically treated, preferably biocompatible surface. In a further advantageous embodiment, the surface of the shaft region may also have a combination or gradient of individual or all of the surface modifications described above.

Advantageously, the base body of the dental implant is specifically designed to provide both screw region and thread-free retained stem region. For this purpose, the screw region advantageously has a length of at most 40%, preferably at most ⅓, preferably at most ¼, of the total length of the base body. Correspondingly and correspondingly, the threadless shank. region advantageously has a length of at least 60%, preferably at least ⅔, preferably at least ¾, of the total length of the basic body.

The combination of the spatially limited screw region with the threadless shaft region provided in accordance with the invention is particularly advantageous for implants of comparatively large overall length. Particularly preferably, therefore, the base body has an overall length of at least 6 mm, especially preferably of at least 8 mm.

Advantageously, the screw region generally, but preferably in combination with the aforementioned length values for the basic body as a whole, has a length of at most 4 mm, preferably at most 3 mm. Accordingly, and in an alternative or additional advantageous embodiment considered to be independently inventive, the external thread has at most four, very particularly preferably and in view of the primary stability surprisingly achievable thereby also considered to be independently inventive, at most three, thread turns. In this context, “thread turn” of a screw thread is to be understood as that part of the screw thread which, starting from any point of the screw thread, is traversed during a single complete revolution around the thread core.

In a particularly preferred further embodiment, the implant is designed to be especially suitable for immediate restoration of a patient with single-tooth crowns, which does not permit load distribution over several implants connected by prosthetic constructions (bridges, bars, etc.). For this purpose, the thread in the screw area is advantageously designed as a so-called “aggressive” thread, which has comparatively deep thread flanks, especially at the implant tip (at the apex). This makes it possible to achieve good primary stability of the implant even soft bone.

In a further advantageous embodiment, the base body has a round or oval cross-section in the shaft region. Furthermore, the base body is advantageously designed in the shaft region with a cross-section that tapers as seen in the longitudinal direction of the base body, i.e. in particular conical.

The dental implant can be designed as a one-piece implant, in which the prosthetic restoration for the patient is attached directly to the base body after insertion of the base body into the jawbone. Alternatively and preferably, the implant can also be designed for use in a two-part implant system, in which a so-called abutment or abutment part is first placed on the inserted base body, which in turn carries the actual prosthetic restoration for the patient. The free end of the shaft area of the base body is preferably designed for connection to the abutment, i.e. adapted to the connection system provided.

Advantageously, the base body is formed from a suitably selected, biocompatible material suitable for osseointegration, particularly preferably titanium.

The advantages achieved with the invention consist in particular in the fact that, due to the combination of a screw region with an external thread, which is limited to the apical end region of die base body, with the screw region in the endosseous region, on the one hand, good primary and secondary stability during insertion and, after osseointegration, a load-bearing capacity of the implant which also meets high demands can be achieved while, on the other hand, therapeutic access is particularly facilitated if necessary and especially in the event of inflammation.

In this way, the dental implant can fulfill the folio five design criteria particularly effectively by means that are kept particularly simple:

1. immediate restoration of single-tooth implants: Immediately after placement of single-tooth implants, a single-tooth crown can be cemented in non-functional occlusion. After complete osseointegration of the implant, a functional occlusion is realized. In particular, if the length of the screw region is about 3 to 4 mm, as preferred, and the screw region is provided with comparatively deep thread flanks, a single-tooth crown can be fixed in non-functional occlusion after insertion of single-tooth implants. Further thread portions on the implant are not required. The primary stability achieved is sufficient for immediate restoration of a single-tooth implant.

2. minimally invasive therapy in case of mucositis or periimplantitis: in case of an incipient disease of the peri-implant tissue (mucositis/periimplantitis), no therapeutic implantoplasty (leveling and smoothing of the implant surface) is required, since the portion of the endosseous implant body adjacent to the soft tissue does not have a thread. Even in the case of progressive peri-implantitis, if peri-implant bone resorption is several mm, implantoplasty is not required with this macrodesign.

3. minimally invasive implant removal: the removal of an osseointegrated implant should cause only minimal peri-implant bone loss, relatively independent of its length and its diameter. Removal of the implant body according to the invention is possible by unscrewing it from the bone bed relatively independently of its length and its diameter, because the majority of the implant body is not threaded.

4. Atraumatic implant insertion: The insertion of an implant should cause low friction and thus low heating of the coritical compacta of the peri-implant bone, relatively independently of its length, its diameter and its material. The insertion of the implant body according to the invention produces only low friction and thus only low heating of the coritical compacta of the peri-implant bone due to the short: portion provided with a thread. Atraumatic implant insertion is thus relatively independent of implant length, implant diameter and implant material.

5. osteotomy protocol independent of mechanical bone properties: The surgical steps and instruments used to create the bone cavity to receive a screw implant should be independent of the biomechanical nature of the bone (hard vs. soft bone quality) in order to simplify bone preparation ( osteotomy). According to the invention, the threads occurring exclusively in the apical part of the implant mostly engage in cancellous bone marrow and are thus mostly localized in soft bone. An osteotomy protocol can thus be reduced to implant placement in soft bone, because the remaining implant portion surrounded by hard cortical bone does not have threads and thus high friction in hard bone. The surgical steps and instruments used to create the bone cavity to receive a screw implant thus become relatively independent of the biomechanical nature of the bone (hard vs. soft bone quality).

### BRIEF DESCRIPTION OF THE DRAWINGS

An embodiment of the invention is explained in more detail with reference to a drawing. Therein are shown:

FIG. 1 depicts a dental implant intended for insertion into the jawbone of a patient, and

FIG. 2 depicts art alternative embodiment of the dental implant according to FIG. 1.

Identical parts are marked with the same reference numerals in both figures.

### DETAILED DESCRIPTION OF THE DRAWINGS

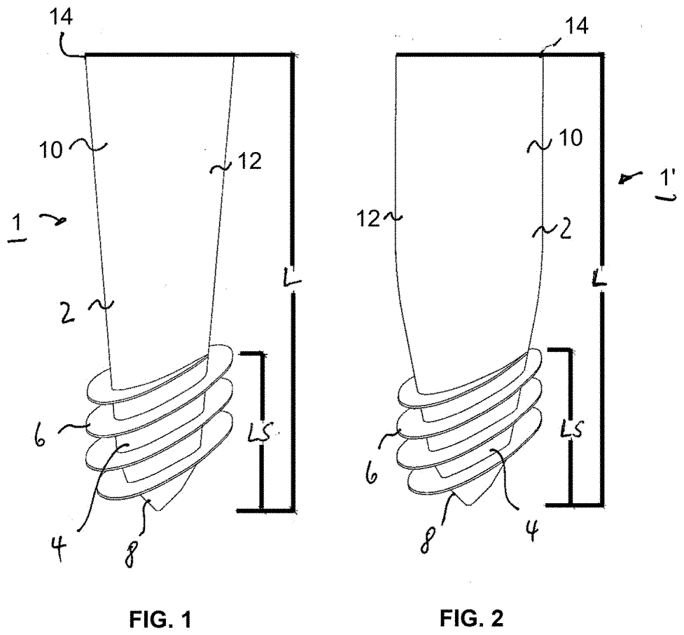

The dental implant 1 according to FIG. 1 is intended for insertion into the jawbone of a patient and comprises, in a conventional design, a base body 2 which is provided with a circumferential external thread 6 in an apically arranged screw region 4 on its outer side. The dental implant 1 is designed, on the one hand, to ensure a particularly high primary and secondary stability and thus to particularly favor the healing process. whereby, on the other hand, however, the containment or treatment of an inflammation possibly occurring in the surrounding bone tissue should also be facilitated in a particularly favorable manner with the dental implant 1 already inserted.

To this end, the design of the dental implant 1 makes use of the realization that the essential contributions to the stability and mechanical load-bearing capacity of the implant are made by the apical end region 8 of the external thread 6. Accordingly, the upper endosseous shaft area 10 can be kept thread-free without having to accept any significant impairment of the primary or secondary stability of the inserted dental implant 1 or the load-bearing capacity after osseointegration has taken place. The base body 2 is thus designed without threads in the proximal. shaft area 10 provided. in addition to the screw area 4 and directly adjacent to the screw area 4. This facilitates access to the implant surface When therapeutic measures become necessary, makes it easier to remove the inserted implant if necessary, and reduces the risk of metal chips contaminating the surrounding tissue in the case of implantoplasty (leveling and smoothing of the implant surface).

The outer surface 12 of the shaft area 10 is specifically designed to have the desired properties to promote healing and/or osseointegration. It could be machined or polished for this purpose. In the embodiment example, however, the outer surface 12 in the shaft area 10 is designed to be thread-free and thus smooth from a macroscopic point of view, but from a microscopic point of view it also has a surface structure that is particularly favorable for osseointegration. For this purpose, the base body 2 has an outer surface 12 in the shaft area 10 with a roughness with a roughness value Ra of approximately 2 μm. Alternatively or additionally, the base body 2 can also have a surface in its shaft region 10 that is particularly favorable for osseointegration in terms of its structure, coating and/or pretreatment.

The base body 2 is designed to provide both screw region 4 and thread-free shaft region 10, In the embodiment example, the base body 2 has an overall length L of approximately 11 mm. In contrast, the screw region 4 is limited to a length LS of about 3.2 mm, whereas the thread-free shank region 10 occupies a length of about 7.8 mm. In the embodiment example, the screw area 4 thus accounts for 29% of the total length L of the basic body 2, and the shank area accounts for 71% of the total length L of the basic body 2. The targeted limit values of at most 40% for the screw region 4 and/or at least 60% for the unthreaded shank region 10 are thus clearly complied with in the embodiment example, Furthermore, as can be clearly seen from the illustrations in FIGS. 1 and 2, the external thread 6 in the embodiment example has only 3 complete thread turns.

The external thread 6 in the screw area 4 is designed as a so-called “aggressive” thread, which has comparatively deep thread flanks, particularly in the apical end area 8.

In the embodiment example, both in the shank area 10 and in the screw area 4, the base body 2 is designed with a cross-section tapering towards the apical end area 8 as viewed in the longitudinal direction of the base body 2, i..e. in particular conical.

In the embodiment example according to FIG. 1, the base body 2 is designed with a round cross-section in the shaft region 10. In contrast, in the alternative embodiment example according to FIG. 2, the dental implant 1′ has an oval cross-section in the shaft region 10 of the basic body 2.

In both variants shown, the dental implant 1, 1′ can be designed as a one-piece implant in which the prosthetic restoration for the patient is attached directly to the base body 2 after insertion of the base body 2 into the jawbone. However, the variants in which the respective base body 2 is intended for use in a two-part. or multi-part implant system are shown in each. case, in which an abutment, which is not shown in more detail, is initially placed on the inserted base body 2, which in turn carries the actual prosthetic restoration for the patient. The free end. 14 of the shaft area 10 of the basic body 2 is designed for connection to the abutment, i.e. it is adapted. to the respective connection system provided.

In the examples shown, the base body 2 is formed from a suitably selected, biocompatible material suitable for osseointegration, in the embodiment example from titanium.

### LIST OF REFERENCE SIGNS

1 Dentalimplantat
2 Basic body
4 Screw range
6 External thread
8 Apical end region
10 Shaft area
12 Outer surface
14 Free end
Total length
LS Length of the shaft area

1. A dental implant intended for insertion into the jawbone of a patient, comprising a basic body that comprises on its outside a circumferential external thread in an apically arranged screw region and is designed to be thread-free in a proximal shaft region which is provided in addition to the screw region, adjoins the screw region, and is likewise provided for osseointegration, wherein the screw region has a length of at most 4 mm, preferably at most 3 mm.

2. The dental implant of claim 1, which is designed in its screw region with wherein-the-external-thread is a self-tapping thread with comparatively deep thread flanks.

3. The dental implant of claim 1, wherein the shaft region comprises a polished outer surface.

4. The dental implant of claim 1, wherein the base body comprises an outer surface in the shaft region with a roughness with a roughness value Ra of at least 1 μm, preferably from 1.5 μm to 3.5 μm.

5. The dental implant of claim 1, wherein the base body comprises a biocompatible surface structure or coating in the shaft region.

6. The dental implant of claim 1, whose screw region has a length of at most ⅓, preferably at most ¼, of a total length of the basic body.

7. The dental implant of claim 1, wherein the threadless shaft region has a length of at least ⅔, preferably at least ¾, of a total length of the basic body.

8. The dental implant of claim 1, wherein the external thread comprises at most four, preferably at most three, thread turns.

9. The dental implant of claim 1, wherein the base body comprises a round cross-section in the shaft region.

10. The dental implant of claim 1, wherein the base body comprises an oval cross-section in the shaft region.

11. The dental implant of claim 1, wherein the base body comprises a tapered cross-section in the shaft region as viewed in a longitudinal direction of the base body.
